(19) United States
(12) Patent Application Publication
(10) Pub. No.: US 2004/0182273 A1
(43) Pub. Date: Sep. 23, 2004

(54) Ink for fabric printing, and printing method

(75) Inventors: Hidemasa Sawada, Nagoya-shi (JP); Takashi Kawaguchi, Nagoya-shi (JP); Akiko Mizuno, Nagoya-shi (JP); Shiro Mori, Kawanishi-shi (JP)

Correspondence Address: OLIFF & BERRIDGE, PLC, P.O. BOX 19928, ALEXANDRIA, VA, 22320, US

(73) Assignees: BROTHER KOGYO KABUSHIKI KAISHA, Nagoya-shi (JP); FUJI PIGMENT CO., LTD., Kawanishi-shi (JP)

(21) Appl. No.: 10/773,207

(22) Filed: Feb. 9, 2004

(30) Foreign Application Priority Data
Mar. 20, 2003 (JP) 2003-078101

(51) Int. Cl. B41F 31/00

(52) U.S. Cl. 101/491

(57) ABSTRACT

An ink for fabric printing contains a pigment and a resin emulsion. The weight ratio between the pigment and the resin emulsion by solid basis is between 1:0.7 and 1:3.0. A printing method has a printing step, in which printing is performed by causing the ink for fabric printing to adhere to a fabric; and a fixing step, in which the ink for fabric printing applied to the fabric in the printing step is fixed to the fabric by heating.

### BACKGROUND OF THE INVENTION

1. Field of the Invention

The present invention relates to an ink for fabric printing and a printing method that are used to form an ink image on a fabric by discharging the ink by ink jet method, for example.

2. Description of the Related Art

A printing method in which ink jet recording is employed to form an ink image on a fabric has been known in the past (see Japanese Laid-Open Patent Application H8-283636). With this printing method, first an ink containing a dye is discharged onto a fabric by ink jet method to form the desired image, and then the dye is fixed to the fabric by heat treatment.

Another known method for forming an image on a fabric is to form a resin layer on the surface of the fabric by coating with a plastisol ink containing a resin such as vinyl chloride.

However, with an ink jet recording method that makes use of a dye, when the ink is fixed by heating, some of the dye remains unfixed (unreacted), and the dye contained in the ink is inadequately fixed to the fabric, which is a problem in that repeated laundering of the fabric washes out the dye and the color fades.

Moreover, after carrying out the printing method, a washing step for removing the dye unfixed to the fabric (unreacted dye) was necessary. Therefore, the problem was that the energy costs had increased due to an increase in the number of steps entailed by printing. Further, the washing water had to be treated since it became polluted, which would enlarge the environmental burdens.

Meanwhile, problems encountered with a method involving coating with a plastisol ink containing a resin such as vinyl chloride are that the use of screen printing necessitates the production of a screen; the thick resin layer formed on the surface of the fabric makes the fabric feel stiff; perspiration absorbency decreases; plasticity decreases over time, causing unsightly cracks to form in the resin layer; and so on.

### SUMMARY OF THE INVENTION

The present invention was conceived in light of the above, and it is an object thereof to provide an ink for fabric printing and a printing method with which laundering fastness is good, printing entails fewer steps, there is less impact on the environment, and the resulting fabric is excellent in terms of feel, perspiration absorbancy, appearance, and so forth.

(1) The present invention provides an ink for fabric printing, comprising a pigment and a resin emulsion, wherein the weight ratio between the pigment and the resin emulsion by solid basis is between 1:0.7 and 1:3.0.

The ink for fabric printing of the present invention will have high print density and good laundering fastness if the weight ratio of the resin emulsion by solid basis to the pigment is at least 0.7. Specifically, when the ink for fabric printing of the present invention is used to print a fabric and then heat-fixed with an iron or the like, the pigment is securely fixed to the fabric by the resin emulsion, so there is less decrease in density when the fabric is laundered.

Furthermore, with the ink for fabric printing of the present invention, the pigment has good fixability to fabric as mentioned above, which means that almost all of the pigment in the ink can be fixed to the fabric. Therefore, there is no need for printing to be followed by a washing step for removing the unfixed pigment. This reduces the number of steps entailed by printing, and since there is no washing water, there is less impact on the environment.

Also, if the weight ratio of the resin emulsion by solid basis to the pigment is 3.0 or less, head discharge and intermittent discharge will be improved when printing is performed using an ink jet printer or the like.

In other words, when printing is performed, the ink can be discharged smoothly from the various nozzles of the ink jet head (head discharge is good), and when printing is recommenced after having been halted for a specific length of time, there are no nozzles on the ink jet head from which no ink is discharged (intermittent discharge is good).

Furthermore, when the ink for fabric printing of the present invention is made to adhere to a fabric, since it does not form a thick resin layer on the surface of the fabric, unlike inks containing resins such as vinyl chloride, the fabric does not feel stiff, there is no decrease in perspiration absorbency, and the appearance of the fabric is not diminished by cracks in the resin layer.

Examples of the abovementioned pigment include black (carbon black; C.I. Pigment Black 7), yellow (monoazo yellow; C.I. Pigment Yellow 74), cyan (phthalocyanine blue; C.I. Pigment Blue 15:3), magenta (quinacridone red; C.I. Pigment Red 122), and the like.

Examples of the abovementioned resin emulsion include acrylic emulsions, vinyl acetate emulsions, urethane emulsions, polyester emulsions, silicone emulsions, olefin emulsions, and the like.

Examples of the abovementioned fabric include cotton, polyester, and cotton/polyester blends.

The ink for fabric printing of the present invention can also contain other components such as pigment dispersants, water-soluble organic solvents, surfactants, and pH regulators.

Examples of pigment dispersants include acrylic acid copolymers. The amount added thereof is from 0.2 to 8 wt %, for example.

The water-soluble organic solvent is a component for regulating viscosity and prevent water evaporation, and examples include glycerin, ethylene glycol, diethylene glycol, and propylene glycol. The amount added thereof is from 10 to 60 wt %, for example.

The surfactant is a component for regulating the surface tension of the ink for fabric printing, and examples include acetylene glycol, alkylphenol ethylene oxide adducts, alkylbenzenesulfonates, sorbitan fatty acid esters, and the like. The amount added thereof is from 0.01 to 5 wt %, for example.

The pH regulator is a component for fine-tunning and maintaining the pH, and examples include triethanolamine, diethanolamine, tris(hydroxymethyl)aminomethane, sodium carbonate, and the like. The amount added thereof is from 0.01 to 5 wt %, for example.

(2) In the ink for fabric printing according to the present invention, it is preferable that the weight ratio between the pigment and the resin emulsion by solid basis is between 1:1.0 and 1:3.0.

The ink for fabric printing of the present invention will have even better laundering fastness if the weight ratio of the resin emulsion by solid basis to the pigment at least 1.0. Specifically, when the ink for fabric printing of the present invention is used to print a fabric and then heat-fixed with an iron or the like, there will be even less decrease in density when the fabric is laundered.

(3) In the ink for fabric printing according to the present invention, it is preferable that the particles of the resin emulsion are produced in the liquid.

Since the resin emulsion particles contained in the ink for fabric printing of the present invention are produced in the liquid, these particles are spherical, or at least have a roundish shape. The result is that the ink for fabric printing of the present invention has the effect of allowing stable discharge from an ink jet head even when the solid concentration in the resin emulsion is increased.

Examples of how the particles of resin emulsion can be produced in the liquid include emulsion polymerization, suspension polymerization, and a method in which a solution in which a resin component has been dissolved is quickly added dropwise into water to produce resin emulsion particles.

(4) In ink for fabric printing according to the present invention, it is preferable that the particles of the resin emulsion are spherical.

With the ink for fabric printing of the present invention, because the particles of the resin emulsion component are spherical, stable discharge from an ink jet head can be achieved even though the solid concentration of the resin emulsion is increased, among other benefits.

The word “spherical” as used here means that the ratio of major diameter to minor diameter of the spherical particles is between 1:1 and 1:0.7 when measured using a scanning electron microscope, for example.

(5) The present invention also provides a printing method, comprising a printing step, in which printing is performed by causing the ink for fabric printing according to the present invention to adhere to a fabric, and a fixing step, in which the ink for fabric printing applied to the fabric in the printing step is fixed to the fabric by heating.

With the printing method of the present invention, the printing step is carried out using the ink for fabric printing according to the present invention, which allows printing with good laundering fastness to be performed, and results in good head discharge and intermittent discharge when an ink jet printer is used in the printing step.

Also, because the present invention includes a fixing step, the fixability of the pigment and resin emulsion to the fabric is improved, and laundering fastness is even better.

Furthermore, since the use of an ink containing a resin such as vinyl chloride is not required with the printing method of the present invention, no thick resin layer is formed on the surface of the fabric, the fabric does not feel stiff, there is no decrease in perspiration absorbancy, and the appearance of the fabric is not diminished by cracks in the resin layer.

In the abovementioned printing step, the ink for fabric printing can be made to adhere to the fabric by using an ink jet head, a fabric conveyance apparatus, and so forth, for example.

In the abovementioned fixing step, the heating can be accomplished with an iron, for example. The heating temperature is at least 150° C., for example, so that the pigment and resin emulsion can be sufficiently fixed to the fabric, but the temperature should not be so high that the fabric is damaged. A heating time of at least 30 seconds is favorable.

### DESCRIPTION OF THE PREFERRED EMBODIMENTS

Embodiments (examples) of the ink for fabric printing of the present invention will now be described.

### EXAMPLE 1

a) The method for manufacturing the ink for fabric printing will be described.

The following components were mixed in their respective proportions and dispersed in a sand mill to manufacture inks for fabric printing of Examples 1-1 to 1-8. Table 1 shows the carbon black concentration (A), the resin emulsion concentration (B), and the ratio B/A thereof for the inks for fabric printing of Examples 1-1 to 1-8 and of aftermentioned Comparative Examples 1-1 to 1-9.

The resin emulsions contained in the inks for fabric printing of Examples 1-1 to 1-8 were manufactured by emulsion polymerization, and the emulsion particles thereof were spherical. In the various inks for fabric printing, the balance other than the components listed below was pure water.

TABLE 1

| | | | Emulsion | | | | | | |
|---|---|---|---|---|---|---|---|---|---|
| | | Pigment | concentration | | | | OD value | | Visual comparison |
| | | concentration | by solid basis | B/A | Head | Intermittent | Before | After | before and after |
| | | (A) (wt %) | (B) (wt %) | ratio | discharge | discharge | laundering | laundering | laundering |
| Ex. | 1-1 | 8 | 6 | 0.75 | good | good | 1.15 | 1.00 | good |
| | 1-2 | 8 | 7 | 0.88 | good | good | 1.20 | 1.05 | good |
| | 1-3 | 8 | 8 | 1.00 | good | good | 1.20 | 1.10 | excellent |
| | 1-4 | 8 | 9 | 1.13 | good | good | 1.20 | 1.10 | excellent |
| | 1-5 | 8 | 10 | 1.25 | good | good | 1.20 | 1.10 | excellent |
| | 1-6 | 8 | 16 | 2.00 | good | good | 1.25 | 1.20 | excellent |
| | 1-7 | 8 | 20 | 2.50 | good | good | 1.25 | 1.25 | excellent |
| | 1-8 | 8 | 24 | 3.00 | good | good | 1.25 | 1.25 | excellent |
| CE | 1-1 | 5 | 0 | 0 | good | good | 0.80 | 0.40 | poor |
| | 1-2 | 6 | 0 | 0 | good | good | 0.85 | 0.40 | poor |
| | 1-3 | 7 | 0 | 0 | good | good | 0.90 | 0.40 | poor |
| | 1-4 | 8 | 0 | 0 | good | good | 1.00 | 0.50 | poor |
| | 1-5 | 8 | 5 | 0.63 | good | good | 1.10 | 0.90 | poor |
| | 1-6 | 8 | 25 | 3.13 | good | poor | 1.30 | 1.25 | excellent |
| | 1-7 | 8 | 26 | 3.25 | good | poor | 1.30 | 1.25 | excellent |
| | 1-8 | 8 | 27 | 3.38 | poor | poor | 1.00 | 1.00 | excellent |
| | 1-9 | 8 | 28 | 3.50 | poor | poor | 0.90 | 0.90 | excellent |

[Ex.: Examples;
CE: Comparative Examples]

### Example 1-1

Carbon black^{*1}: 8 wt %

(Raven 1250 (Pigment Black 7), pigment; available from Columbian Carbon Japan Limited)

Acrylic acid copolymer^{*2}: 1.6 wt %

(Joncryl 678, pigment dispersant; available from Johnson Polymer, Inc.)

Acrylic resin emulsion^{*3}: 6 wt % (by solid basis)

(Newcoat #1182; available from Shin-Nakamura Chemical Co., Ltd.)

Diethylene glycol (water-soluble organic solvent): 20 wt %

Acetylene glycol (surfactant): 0.1 wt %

Triethanolamine (pH regulator): 0.1 wt %

### Example 1-2

Carbon black^{*1}: 8 wt %

Acrylic acid copolymer^{*2}: 1.6 wt %

Acrylic resin emulsion^{*3}: 7 wt % (by solid basis)

Diethylene glycol (water-soluble organic solvent): 20 wt %

Acetylene glycol (surfactant): 0.1 wt %

Triethanolamine (pH regulator): 0.1 wt %

### Example 1-3

Carbon black^{*1}: 8 wt %

Acrylic acid copolymer^{*2}: 1.6 wt %

Acrylic resin emulsion^{*3}: 8 wt % (by solid basis)

Diethylene glycol (water-soluble organic solvent): 20 wt %

Acetylene glycol (surfactant): 0.1 wt %

Triethanolamine (pH regulator): 0.1 wt %

### Example 1-4

Carbon black^{*1}: 8 wt %

Acrylic acid copolymer²: 1.6 wt %

Acrylic resin emulsion^{*3}: 9 wt % (by solid basis)

Diethylene glycol (water-soluble organic solvent): 20 wt %

Acetylene glycol (surfactant): 0.1 wt %

Triethanolamine (pH regulator): 0.1 wt %

### Example 1-5

Carbon black^{*1}: 8 wt %

Acrylic acid copolymer^{*2}: 1.6 wt %

Acrylic resin emulsion^{*3}: 10 wt % (by solid basis)

Diethylene glycol (water-soluble organic solvent): 20 wt %

Acetylene glycol (surfactant): 0.1 wt %

Triethanolamine (pH regulator): 0.1 wt %

### Example 1-6

Carbon black^{*1}: 8 wt %

Acrylic acid copolymer^{*2}: 1.6 wt %

Acrylic resin emulsion^{*3}: 16 wt % (by solid basis)

Diethylene glycol (water-soluble organic solvent): 20 wt %

Acetylene glycol (surfactant): 0.1 wt %

Triethanolamine (pH regulator): 0.1 wt %

### Example 1-7

Carbon black^{*1}: 8 wt %

Acrylic acid copolymer^{*2}: 1.6 wt %

Acrylic resin emulsion^{*3}: 20 wt % (by solid basis)

Diethylene glycol (water-soluble organic solvent): 20 wt %

Acetylene glycol (surfactant): 0.1 wt %

Triethanolamine (pH regulator): 0.1 wt %

### Example 1-8

Carbon black^{*1}: 8 wt %

Acrylic acid copolymer^{*2}: 1.6 wt %

Acrylic resin emulsion^{*3}: 24 wt % (by solid basis)

Diethylene glycol (water-soluble organic solvent): 20 wt %

Acetylene glycol (surfactant): 0.1 wt %

Triethanolamine (pH regulator): 0.1 wt %

As comparative examples, the components listed below were mixed in their respective proportions and dispersed in a sand mill to manufacture inks for fabric printing of Comparative Examples 1-1 to 1-9. The resin emulsions contained in the inks for fabric printing were manufactured by emulsion polymerization, and the emulsion particles thereof were spherical. In the various inks for fabric printing, the balance other than the components listed below was pure water.

### Comparative Example 1-1

Carbon black^{*1}: 5 wt %

Acrylic acid copolymer^{*2}: 1.0 wt %

Diethylene glycol (water-soluble organic solvent): 20 wt %

Acetylene glycol (surfactant): 0.1 wt %

Triethanolamine (pH regulator): 0.1 wt %

### Comparative Example 1-2

Carbon black^{*1}: 6 wt %

Acrylic acid copolymer^{*2}: 1.2 wt %

Diethylene glycol (water-soluble organic solvent): 20 wt %

Acetylene glycol (surfactant): 0.1 wt %

Triethanolamine (pH regulator): 0.1 wt %

### Comparative Example 1-3

Carbon black^{*1}: 7 wt %

Acrylic acid copolymer²: 1.4 wt %

Diethylene glycol (water-soluble organic solvent): 20 wt %

Acetylene glycol (surfactant): 0.1 wt %

Triethanolamine (pH regulator): 0.1 wt %

### Comparative Example 1-4

Carbon black^{*1}: 8 wt %

Acrylic acid copolymer^{*2}: 1.6 wt %

Diethylene glycol (water-soluble organic solvent): 20 wt %

Acetylene glycol (surfactant): 0.1 wt %

Triethanolamine (pH regulator): 0.1 wt %

### Comparative Example 1-5

Carbon black^{*1}: 8 wt %

Acrylic acid copolymer^{*2}: 1.6 wt %

Acrylic resin emulsion^{*3}: 5 wt % (by solid basis)

Diethylene glycol (water-soluble organic solvent): 20 wt %

Acetylene glycol (surfactant): 0.1 wt %

Triethanolamine (pH regulator): 0.1 wt %

### Comparative Example 1-6

Carbon black^{*1}: 8 wt %

Acrylic acid copolymer^{*2}: 1.6 wt %

Acrylic resin emulsion^{*3}: 25 wt % (by solid basis)

Diethylene glycol (water-soluble organic solvent): 20 wt %

Acetylene glycol (surfactant): 0.1 wt %

Triethanolamine (pH regulator): 0.1 wt %

### Comparative Example 1-7

Carbon black^{*1}: 8 wt %

Acrylic acid copolymer^{*2}: 1.6 wt %

Acrylic resin emulsion^{*3}: 26 wt % (by solid basis)

Diethylene glycol (water-soluble organic solvent): 20 wt %

Acetylene glycol (surfactant): 0.1 wt %

Triethanolamine (pH regulator): 0.1 wt %

### Comparative Example 1-8

Carbon black^{*1}: 8 wt %

Acrylic acid copolymer^{*2}: 1.6 wt %

Acrylic resin emulsion^{*3}: 27 wt % (by solid basis)

Diethylene glycol (water-soluble organic solvent): 20 wt %

Acetylene glycol (surfactant): 0.1 wt %

Triethanolamine (pH regulator): 0.1 wt %

### Comparative Example 1-9

Carbon black^{*1}: 8 wt %

Acrylic acid copolymer^{*2}: 1.6 wt %

Acrylic resin emulsion^{*3}: 28 wt % (by solid basis)

Diethylene glycol (water-soluble organic solvent): 20 wt %

Acetylene glycol (surfactant): 0.1 wt %

Triethanolamine (pH regulator): 0.1 wt %

The ratios of the resin emulsion content to the pigment content in Comparative Examples 1-1 to 1-5 were less than 0.7 and therefore outside the range of the present invention. In Comparative Examples 1-6 to 1-9, the ratios of the resin emulsion content to the pigment content were over 3.0 and therefore outside the range of the present invention.

b) Next, a printing method in which a fabric is printed using the inks for fabric printing of Example 1 will be described. 100% cotton fabric was printed at 50 pl×600 dpi with a Brother IJ printer (printing step).

Next, an iron was used to heat the printed portion for 40 seconds at a temperature of 180° C. and thereby fix the ink for fabric printing to the fabric (fixing step).

c) Next, the effects of the inks for fabric printing of Example 1 and the above printing method will be described.

\mathring{1} The inks for fabric printing of Example 1 has good laundering fastness because the weight ratio of the resin emulsion (by solid basis) to the pigment is at least 0.7. That is, when the ink for fabric printing of this example is used to print a fabric and heat heat-fixed with an iron or the like, the pigment is securely affixed to the fabric, so there is little decrease in density when the fabric is laundered. The print density is also high (1.15 or higher).

Furthermore, with the inks for fabric printing of Example 1, because the pigment is securely affixed to the fabric as mentioned above, there is no need for a washing step after printing in order to remove any unfixed pigment. This reduces the number of steps entailed by printing, and since there is no washing water, there is less impact on the environment.

\mathring{2} Because the weight ratio of the resin emulsion (by solid basis) to the pigment is no more than 3.0 in the inks for fabric printing of Example 1, head discharge and intermittent discharge are both good during printing with an ink jet printer.

Specifically, when printing is performed, the ink can be discharged smoothly from the various nozzles of the ink jet head (head discharge is good), and when printing is recommenced after having been halted for a specific length of time, there are no nozzles on the ink jet head from which no ink is discharged (intermittent discharge is good).

\mathring{3} Because the inks for fabric printing of Example 1 does not form a thick resin layer on the surface of the fabric, unlike plastisol inks containing resins containing a resin such as vinyl chloride, the fabric does not feel stiff, there is no decrease in perspiration absorbancy, and the appearance of the fabric is not diminished by cracks in the resin layer.

d) Next, we will describe an experiment conducted in order to confirm the effects of the inks for fabric printing of Example 1 and the abovementioned printing method.

(i) Test of Laundering Fastness

The laundering fastness test was carried out according to AATCC 135-1995 IIIA. Specifically, first a 100% cotton fabric was printed in the same manner as in b) above, using the inks for fabric printing from Examples 1-1 to 1-8 and Comparative Examples 1-1 to 1-9. The density of the printed portion was then measured with a Macbeth densitometer (density before laundering).

This fabric was then laundered according to AATCC 135-1995 IIIA, and the density after laundering was measured by the same method as above (density after laundering). These results are given in Table 1.

As shown in Table 1, when the inks for fabric printing of Examples 1-1 to 1-8 were used, the difference in density before and after laundering was 0.15 or less, and the print density after laundering was over 1.0, which confirms that the laundering fastness was good. In contrast, when the inks for fabric printing in Comparative Examples 1-1 to 1-5 were used, the difference in density before and after laundering was 0.2 or greater, and the print density after laundering was less than 1.0, so laundering fastness was poor.

(ii) Head Discharge Test

A surface area equal to 10 sheets of A4-size paper was printed using the inks for fabric printing from Examples 1-1 to 1-8 and Comparative Examples 1-1 to 1-9. The type of printer used and the printing conditions were the same as in b) above.

The head discharge here was considered to be “good” if there was no abnormal printing within the printed area, but “poor” if there was any abnormal printing. “Abnormal printing” as used here means that no ink was discharged from one or more of the nozzles of the ink jet head, or that ink adhered somewhere other than where it was supposed to adhere. The results of evaluating head discharge are given in the abovementioned Table 1.

As shown in Table 1, when the inks for fabric printing of Examples 1-1 to 1-8 were used, head discharge was rated “good” in every case. These results confirm that the inks for fabric printing of Examples 1-1 to 1-8 are discharged well from the head. In contrast, the evaluation was “poor” when the inks for fabric printing in Comparative Examples 1-8 and 1-9 were used.

(iii) Intermittent Discharge Test

A surface area equal to 1 sheet of A4-size paper was printed using the inks for fabric printing from Examples 1-1 to 1-8 and Comparative Examples 1-1 to 1-9, after which the product was allowed to stand for 15 minutes, and then printing was again performed over an area equal to 1 sheet of A4-size paper. The type of printer used and the printing conditions were the same as in b) above.

The intermittent discharge was considered to be “good” if there was no abnormal printing on the paper printed after a pause of 15 minutes, but “poor” if there was any abnormal printing. The results of evaluating intermittent discharge are given in the abovementioned Table 1.

As shown in Table 1, when the inks for fabric printing of Examples 1-1 to 1-8 were used, intermittent discharge was rated “good” in every case. These results confirm that the inks for fabric printing of Examples 1-1 to 1-8 are intermittently discharged well from the head.

In contrast, the intermittent discharge was rated “poor” when the inks for fabric printing in Comparative Examples 1-6 to 1-9 were used.

(iv) Visual Comparison Test Before and After Laundering

The printed portion was examined visually before and after the laundering in (i) above. These results are given in Table 1.

As shown in Table 1, when the inks for fabric printing of Examples 1-1 to 1-8 were used, there was no change whatsoever in the appearance of the fabric before and after laundering (“excellent” rating), or there was almost no change (“good” rating).

In contrast, in Comparative Examples 1-1 to 1-5, the printed portion of the laundered fabric had developed pilling and turned white (“poor” rating).

### EXAMPLE 2

a) The following components were mixed in their respective proportions and dispersed in a sand mill to manufacture inks for fabric printing of Examples 2-1 to 2-8. Table 2 shows the pigment concentration (A), the resin emulsion concentration (B), and the ratio B/A thereof for the inks for fabric printing of Examples 2-1 to 2-8 and of aftermentioned Comparative Examples 2-1 to 2-9.

The resin emulsions contained in the inks for fabric printing of Examples 2-1 to 2-8 were manufactured by emulsion polymerization, and the emulsion particles thereof were spherical. In the various inks for fabric printing, the balance other than the components listed below was pure water.

TABLE 2

| | | | Emulsion | | | | | | |
|---|---|---|---|---|---|---|---|---|---|
| | | Pigment | concentration | | | | OD value | | Visual comparison |
| | | concentration | by solid basis | B/A | Head | Intermittent | Before | After | before and after |
| | | (A) (wt %) | (B) (wt %) | ratio | discharge | discharge | laundering | laundering | laundering |
| Ex. | 2-1 | 3 | 2.1 | 0.70 | good | good | 0.97 | 0.90 | good |
| | 2-2 | 3 | 2.4 | 0.80 | good | good | 0.98 | 0.94 | good |
| | 2-3 | 3 | 2.7 | 0.90 | good | good | 1.00 | 0.94 | excellent |
| | 2-4 | 3 | 3 | 1.00 | good | good | 1.00 | 0.95 | excellent |
| | 2-5 | 3 | 3.3 | 1.10 | good | good | 1.00 | 0.95 | excellent |
| | 2-6 | 3 | 6 | 2.00 | good | good | 1.05 | 1.05 | excellent |
| | 2-7 | 3 | 7.5 | 2.50 | good | good | 1.05 | 1.05 | excellent |
| | 2-8 | 3 | 9 | 3.00 | good | good | 1.10 | 1.10 | excellent |
| CE | 2-1 | 1 | 0 | 0 | good | good | 0.54 | 0.30 | poor |
| | 2-2 | 1.5 | 0 | 0 | good | good | 0.70 | 0.30 | poor |
| | 2-3 | 2 | 0 | 0 | good | good | 0.76 | 0.40 | poor |
| | 2-4 | 2.5 | 0 | 0 | good | good | 0.80 | 0.50 | poor |
| | 2-5 | 3 | 1.5 | 0.50 | good | good | 0.90 | 0.70 | poor |
| | 2-6 | 3 | 10 | 3.33 | good | poor | 1.10 | 1.10 | excellent |
| | 2-7 | 3 | 15 | 5.00 | good | poor | 1.10 | 1.10 | excellent |
| | 2-8 | 3 | 20 | 6.67 | poor | poor | 1.00 | 1.00 | excellent |
| | 2-9 | 3 | 25 | 8.33 | poor | poor | 0.90 | 0.90 | excellent |

### Example 2-1

Monoazo yellow^{*4}: 3 wt %

(Symuler Fast Yallow 4190 (Pigment Yellow 74), pigment; available from Dainippon Ink and Chemicals, Incoporated)

Acrylic acid copolymer^{*2}: 0.6 wt %

Urethane resin emulsion^{*5}: 2.1 wt % (by solid basis)

(Yodozol RD20, available from Nippon NSC Ltd.)

Diethylene glycol (water-soluble organic solvent): 20 wt %

Acetylene glycol (surfactant): 0.1 wt %

Triethanolamine (pH regulator): 0.1 wt %

### Example 2-2

Monoazo yellow^{*4}: 3 wt %

Acrylic acid copolymer^{*2}: 0.6 wt %

Urethane resin emulsion^{*5}: 2.4 wt % (by solid basis)

Diethylene glycol (water-soluble organic solvent): 20 wt %

Acetylene glycol (surfactant): 0.1 wt %

Triethanolamine (pH regulator): 0.1 wt %

### Example 2-3

Monoazo yellow^{*4}: 3 wt %

Acrylic acid copolymer^{*2}: 0.6 wt %

Urethane resin emulsion^{*5}: 2.7 wt % (by solid basis)

Diethylene glycol (water-soluble organic solvent): 20 wt %

Acetylene glycol (surfactant): 0.1 wt %

Triethanolamine (pH regulator): 0.1 wt %

### Example 2-4

Monoazo yellow^{*4}: 3 wt %

Acrylic acid copolymer^{*2}: 0.6 wt %

Urethane resin emulsion^{*5}: 3 wt % (by solid basis)

Diethylene glycol (water-soluble organic solvent): 20 wt %

Acetylene glycol (surfactant): 0.1 wt %

Triethanolamine (pH regulator): 0.1 wt %

### Example 2-5

Monoazo yellow^{*4}: 3 wt %

Acrylic acid copolymer²: 0.6 wt %

Urethane resin emulsion^{*5}: 3.3 wt % (by solid basis)

Diethylene glycol (water-soluble organic solvent): 20 wt %

Acetylene glycol (surfactant): 0.1 wt %

Triethanolamine (pH regulator): 0.1 wt %

### Example 2-6

Monoazo yellow^{*4}: 3 wt %

Acrylic acid copolymer^{*2}: 0.6 wt %

Urethane resin emulsion^{*5}: 6 wt % (by solid basis)

Diethylene glycol (water-soluble organic solvent): 20 wt %

Acetylene glycol (surfactant): 0.1 wt %

Triethanolamine (pH regulator): 0.1 wt %

### Example 2-7

Monoazo yellow^{*4}: 3 wt %

Acrylic acid copolymer^{*2}: 0.6 wt %

Urethane resin emulsion^{*5}: 7.5 wt % (by solid basis)

Diethylene glycol (water-soluble organic solvent): 20 wt %

Acetylene glycol (surfactant): 0.1 wt %

Triethanolamine (pH regulator): 0.1 wt %

### Example 2-8

Monoazo yellow^{*4}: 3 wt %

Acrylic acid copolymer^{*2}: 0.6 wt %

Urethane resin emulsion^{*5}: 9 wt % (by solid basis)

Diethylene glycol (water-soluble organic solvent): 20 wt %

Acetylene glycol (surfactant): 0.1 wt %

Triethanolamine (pH regulator): 0.1 wt %

As comparative examples, the components listed below were mixed in their respective proportions and dispersed in a sand mill to manufacture inks for fabric printing of Comparative Examples 2-1 to 2-9.

### Comparative Example 2-1

Monoazo yellow^{*4}: 1 wt %

Acrylic acid copolymer^{*2}: 0.2 wt %

Diethylene glycol (water-soluble organic solvent): 20 wt %

Acetylene glycol (surfactant): 0.1 wt %

Triethanolamine (pH regulator): 0.1 wt %

### Comparative Example 2-2

Monoazo yellow^{*4}: 1.5 wt %

Acrylic acid copolymer^{*2}: 0.3 wt %

Diethylene glycol (water-soluble organic solvent): 20 wt %

Acetylene glycol (surfactant): 0.1 wt %

Triethanolamine (pH regulator): 0.1 wt %

### Comparative Example 2-3

Monoazo yellow^{*4}: 2 wt %

Acrylic acid copolymer^{*2}: 0.4 wt %

Diethylene glycol (water-soluble organic solvent): 20 wt %

Acetylene glycol (surfactant): 0.1 wt %

Triethanolamine (pH regulator): 0.1 wt %

### Comparative Example 2-4

Monoazo yellow^{*4}: 2.5 wt %

Acrylic acid copolymer^{*2}: 0.5 wt %

Diethylene glycol (water-soluble organic solvent): 20 wt %

Acetylene glycol (surfactant): 0.1 wt %

Triethanolamine (pH regulator): 0.1 wt %

### Comparative Example 2-5

Monoazo yellow^{*4}: 3 wt %

Acrylic acid copolymer^{*2}: 0.6 wt %

Urethane resin emulsion^{*5}: 1.5 wt % (by solid basis)

Diethylene glycol (water-soluble organic solvent): 20 wt %

Acetylene glycol (surfactant): 0.1 wt %

Triethanolamine (pH regulator): 0.1 wt %

### Comparative Example 2-6

Monoazo yellow^{*4}: 3 wt %

Acrylic acid copolymer^{*2}: 0.6 wt %

Urethane resin emulsion^{*5}: 10 wt % (by solid basis)

Diethylene glycol (water-soluble organic solvent): 20 wt %

Acetylene glycol (surfactant): 0.1 wt %

Triethanolamine (pH regulator): 0.1 wt %

### Comparative Example 2-7

Monoazo yellow^{*4}: 3 wt %

Acrylic acid copolymer^{*2}: 0.6 wt %

Urethane resin emulsion^{*5}: 15 wt % (by solid basis)

Diethylene glycol (water-soluble organic solvent): 20 wt %

Acetylene glycol (surfactant): 0.1 wt %

Triethanolamine (pH regulator): 0.1 wt %

### Comparative Example 2-8

Monoazo yellow^{*4}: 3 wt %

Acrylic acid copolymer^{*2}: 0.6 wt %

Urethane resin emulsion^{*5}: 20 wt % (by solid basis)

Diethylene glycol (water-soluble organic solvent): 20 wt %

Acetylene glycol (surfactant): 0.1 wt %

Triethanolamine (pH regulator): 0.1 wt %

### Comparative Example 2-9

Monoazo yellow⁺⁴: 3 wt %

Acrylic acid copolymer⁺²: 0.6 wt %

Urethane resin emulsion^{*5}: 25 wt % (by solid basis)

Diethylene glycol (water-soluble organic solvent): 20 wt %

Acetylene glycol (surfactant): 0.1 wt %

Triethanolamine (pH regulator): 0.1 wt %

The ratios of the resin emulsion content to the pigment content in Comparative Examples 2-1 to 2-5 were less than 0.7 and therefore outside the range of the present invention. In Comparative Examples 2-6 to 2-9, the ratios of the resin emulsion content to the pigment content were over 3.0 and therefore outside the range of the present invention.

b) Next, fabric was printed by the same printing method as in Example 1 above, but using the inks for fabric printing of Example 2.

c) The inks for fabric printing of Example 2 and the printing method using these inks had the same effects as in Example 1 above.

d) Laundering fastness, head discharge, intermittent discharge, and appearance before and after laundering were then tested in the same manner as in d) in Example 1 above in order to confirm the effects of the inks for fabric printing of Example 2 and the abovementioned printing method. These results are given in the above-mentioned Table 2.

(i) Test of Laundering Fastness

As shown in Table 2, when the inks for fabric printing of Examples 2-1 to 2-8 were used, the difference in density before and after laundering was 0.07 or less, and the print density after laundering was at least 0.9, which confirms that the laundering fastness was good.

In contrast, when the inks for fabric printing in Comparative Examples 2-1 to 2-5 were used, the difference in density before and after laundering was 0.2 or greater, and the print density after laundering was less than 0.7, so laundering fastness was poor.

(ii) Head Discharge Test

As shown in Table 2, when the inks for fabric printing of Examples 2-1 to 2-8 were used, head discharge was rated “good” in every case. These results confirm that the inks for fabric printing of Examples 2-1 to 2-8 are discharged well from the head.

In contrast, the evaluation was “poor” when the inks for fabric printing in Comparative Examples 2-8 and 2-9 were used.

(iii) Intermittent Discharge Test

As shown in Table 2, when the inks for fabric printing of Examples 2-1 to 2-8 were used, intermittent discharge was rated “good” in every case. These results confirm that the inks for fabric printing of Examples 2-1 to 2-8 are intermittently discharged well from the head.

In contrast, the intermittent discharge was rated “poor” when the inks for fabric printing in Comparative Examples 2-6 to 2-9 were used.

(iv) Visual Comparison Test Before and After Laundering

As shown in Table 2, when the inks for fabric printing of Examples 2-1 to 2-8 were used, there was no change whatsoever in the appearance of the fabric before and after laundering (“excellent” rating), or there was almost no change (“good” rating).

In contrast, in Comparative Examples 2-1 to 2-5, the printed portion of the laundered fabric had developed pilling and turned white (“poor” rating).

### EXAMPLE 3

Other than changing the type of pigment to phthalocyanine blue (Fastogen blue TGR (Pigment Blue 15:3); available from Dainippon Ink and Chemicals, Incorporated), inks for fabric printing 3-1 to 3-8 were manufactured in the same manner as the inks for fabric printing of Examples 2-1 to 2-8.

The same tests as in d) of Example 1 above were conducted using these inks for fabric printing 3-1 to 3-8, whereupon the results were the same as for the inks for fabric printing of Examples 2-1 to 2-8.

### EXAMPLE 4

Other than changing the type of pigment to quinacridone red (Toner Magenta E02 (Pigment Red 122); available from Clariant Japan Co., Ltd.), the inks for fabric printing 4-1 to 4-8 were manufactured in the same manner as the inks for fabric printing of Examples 2-1 to 2-8.

The same tests as in d) of Example 1 above were conducted using these inks for fabric printing 4-1 to 4-8, whereupon the results were the same as for the inks for fabric printing of Examples 2-1 to 2-8.

The present invention is not limited in any way to or by the above examples, and it should go without saying that various other embodiments are possible within the scope of the present invention.

The entire disclosure of the specification, claims and summary of Japanese Patent Application No. 2003-78101 filed Mar. 20, 2003 is hereby incorporated by reference.

What is claimed is:

1. An ink for fabric printing, comprising a pigment and a resin emulsion,
wherein the weight ratio between the pigment and the resin emulsion by solid basis is between 1:0.7 and 1:3.0.

2. The ink for fabric printing according to claim 1, wherein the weight ratio between the pigment and the resin emulsion by solid basis is between 1:1.0 and 1:3.0.

3. The ink for fabric printing according to claim 1 or 2, wherein the particles of the resin emulsion are produced in the liquid.

4. The ink for fabric printing according to claim 1, wherein the particles of the resin emulsion are spherical.

5. A printing method, comprising:
a printing step, in which printing is performed by causing the ink for fabric printing according to claim 1 to adhere to a fabric; and
a fixing step, in which the ink for fabric printing applied to the fabric in the printing step is fixed to the fabric by heating.
